(19) United States
(12) Patent Application Publication
(10) Pub. No.: US 2009/0071972 A1
(43) Pub. Date: Mar. 19, 2009

(54) METHOD AND APPARATUS FOR FACILITATING EXCHANGE OF MULTIMEDIA PRODUCTS

(76) Inventors: Olivier Laurent Peyran, Singapore (SG); May Chin Tan, Singapore (SG); Gamaliel Amaudruz, Singapore (SG)

Correspondence Address: FISH & RICHARDSON PC, P.O. BOX 1022, MINNEAPOLIS, MN, 55440-1022, US

(21) Appl. No.: 12/300,069

(22) PCT Filed: May 10, 2007
(86) PCT No.: PCT/SG2007/000131

§ 371 Date: Nov. 7, 2008

(30) Foreign Application Priority Data
May 11, 2006 (SG) 200603222-1

(51) Int. Cl. G07F 17/32; G06Q 30/00; G06Q 50/00

(52) U.S. Cl. 221/8; 705/26

(57) ABSTRACT

A method and apparatus for providing an exchange of multimedia products between a plurality of users is disclosed. For example, a user has a multimedia product to be given up in exchange for either another product desired or exchangeable denomination of value, including cash and/or value points, which may be used in exchange to acquire said multimedia product desired. The method includes collating each user's exchange criteria into a data system, matching a user willing to part with a multimedia product with another user desiring said multimedia product in said data system; collecting said multimedia product desired from said willing user; and dispensing said multimedia product desired to said desiring user. A mutual exchange between 2 matched users is also possible. Kiosks housing a jukebox-like apparatus for depositing and retrieving the products which are in operative control by a data system implemented over the Internet are also disclosed.

### TECHNICAL FIELD

This invention relates to a method for facilitating exchange of multimedia products such as DVD, VCD, CD-ROM, cartridges for games console, etc. between users. In particular, it concerns the exchange of such multimedia products which are pre-owned. An apparatus for carrying out the collection, storing and dispensing of the multimedia products are also disclosed, along with the method's implementation over a wide area network, such as the Internet.

### BACKGROUND ART

In the electronic gaming market, the turnover of games is almost as high as the movies and, like a movie or story book, once played, the user would lose interest after a few repeated plays as the element of surprise, plot familiarity and level of challenge are attained. The user would seek to trade-in their used game, which is normally in good working condition and it is only used to run the executable program on a computer or games console, in exchange for a game new to the user.

For years, owners of electronic games that are normally stored in opto-magnetic discs or other forms such as DVD, VCD, CD-ROM, cartridges for games console, have been trading-in their games to shops and retailers. It has been estimated that in the United Kingdom alone, the market for pre-owned games is estimated to be worth GBP 100 million, giving rise to large games retailer such as GAME in United Kingdom, and Shibuya Tsutaya and Yamada Denki in Japan.

The advantage of a shop by a retailer for such used games is that the owner is assured of his used game would bought up by the shop and he can then choose a game new to him from a wide collection of titles acquired over time by the shop. On the other hand, however, the retailer would have to take on all the risks of the games exchange which can be substantial given the large number of titles to be bought over to achieve a collection size attractive enough for gamers to come to the shop. To mitigate such risk, the retailer would need to trade aggressively, including buying at low price from the user and resell it at a high price. There is also a risk of a game, which might be popular when it is first introduced to the market, becoming passé after a few weeks on the shelf. Hence, the retailer would also have to adopt an aggressive stock management and pricing so that a recent game bought on the “high” side should be sold off quickly, otherwise, after a few weeks a sharp discount has to be given to get rid of it from the shelf. Thus, there are considerable risks to the retailer.

There are forums and classified sections in printed publications or periodicals such as gamers' magazine which enable a user to list his used game for sale or exchange and do nothing else in facilitating the actual exchange or sale. There are also websites, such as the French Gametroc website (www.gametroc.com) which enables consumer-to-consumer interaction. Consumer A lists the game products he is willing to part with and lists the products he is looking for. When Gametroc finds a match (e.g. Consumer B who wants a product to be given up by Consumer A), Gametroc will provide details of B to A who has to send the product to B by post. Once sent, A is credited with a number of points commensurate with the value of the product sent less a transaction fee charged by Gametroc.

Hence, it is not exactly an exchange system because the exchanging parties does not exchange the product via Gametroc and Consumer A does not get any products from B but may use his credit points to get a product from another consumer. It is therefore not a 1-to-1 exchange but an n-to-n exchange. The advantage for Gametroc is it is not required to acquire or stock products and merely provides matches between consumers and takes a fee each time a transaction takes place. Gametroc does not provide an exchange facility and is only an offer to find direct matches between consumers. The disadvantage is that Consumer B could claim he did not receive the product or it could be genuinely lost in the mail and the parties would have no recourse.

Because it is an n-to-n exchange, Consumer A needs to give away his product first (in order to earn the credit points) before being able to get a product he wants. There is also no guarantee that there will be a reverse match for A to get a product he wants. Another disadvantage is that after a few direct contacts, A would be able to contact these few garners directly to offer them products in which case any transaction that materialize will not earn Gametroc any fee.

In another aspect of the technical field, there are existing jukeboxes installed by retailers for dispensing DVD or VCD movies for rental in a business-to-customer (B2C) manner. There are also existing jukeboxes for storing data cartridges with automated collection, indexing, storing and retrieval such as that disclosed in U.S. Pat. No. 6,231,291 (Mueller) wherein data cartridges may be exchanged in a jukebox data storage environment wherein an automated picker is provided to engage a cartridge and move it accordingly.

It is our object to provide a C2C exchange of multimedia products, particularly games in opto-magnetic media including DVD, VCD, CD-ROM, CD-R, CD-R/W, cartridges and the like without the aforementioned disadvantages.

### SUMMARY OF DISCLOSURE

According to the aforesaid object, we now propose a new method and apparatus for providing an exchange of multimedia products wherein in the broad, general embodiment of our invention, a method for facilitating exchange of multimedia products between a plurality of users is provided wherein at least a user has at least (i) a multimedia product to be given up in exchange for either (ii) a multimedia product desired or (iii) exchangeable denomination of value, including cash and/or value points, which may be used in exchange to acquire said multimedia product desired; (hereinafter collectively referred to as “exchange criteria”), said method including the steps of:
(a) collating each user's exchange criteria into a data system;
(b) matching at least a user willing to part with a multimedia product with at least a user desiring said multimedia product in said data system;
(c) collecting said multimedia product desired from said willing user;
(d) dispensing said multimedia product desired to said desiring user preferably, in the aforesaid order recited.

In a first preferred embodiment of our method, the denomination may be credited and debited according to transactions, such as (a) awarding denomination according to at least one or combination of the following factors: original manufacturer's selling price, current market demand, age, and/or popularity of a title or content of the multimedia product;

(b) crediting an amount of value points to a user's account according to paragraph (a) above upon collecting said multimedia product from said user, including converting from cash-deposited by said user;

debiting an amount of value points from a user's account according to (a) upon dispensing said multimedia product, on a periodical basis to reflect delay in collecting, obsolescence or passe, and converting into cash by said user.

In a second preferred embodiment, our method facilitates exchange of multimedia products between a plurality of users wherein at least a first user and a second user each respectively has at least (i) a first and second multimedia products to be given up respectively in exchange for either (ii) a second and first multimedia products desired respectively, and/or (iii) exchangeable denomination of value, including cash and/or value points, which may be used in exchange to acquire said multimedia product desired; the method including the steps of:
(a) collating each of said first and second users' exchange criteria into a data system;
(b) matching at least said first user willing to part with said first multimedia products with at least said second user desiring said first multimedia product, and vice versa in said data system;
(c) collecting said multimedia product desired from each of said first and second users;
(d) dispensing said multimedia product desired to each of said first and second user

preferably, in the aforesaid order recited.

In a third preferred embodiment of our invention, a method is provided for facilitating exchange of multimedia products between a plurality of users including at least a first user and a second user wherein the first user has a first multimedia product which he is willing to exchange for denomination and/or another multimedia product, including a second multimedia product or part or multiple units thereof; the second user has said second multimedia product which he is willing to exchange for credit points or another multimedia, including said first multimedia product; the information on each user's multimedia product to be given away and multimedia product desired referred hereinafter collectively as “exchange criteria”; the method including the steps of:
(a) each of said first and second user independently registering and inputting aforesaid exchange criteria into a data system;
(b) data system matching aforesaid exchange criteria and identify said first and second users;
(c) data system informing each of said first and second users to deposit said first and second multimedia products respectively with at least an apparatus for collecting, storing and dispensing multimedia products in a jukebox manner;
(d) said first and second users depositing said first and second multimedia products with said apparatus accordingly;
(e) said apparatus verifying and updating said first and second multimedia products' deposition with said data system accordingly;
(f) said data system informing said first and second users to collect said second and first multimedia products accordingly from said apparatus and providing respective identification to said first and second users;
(g) each of said first and second user independently presenting respective identification at said apparatus; and
(h) said apparatus authenticating each of said users' identification and dispensing the appropriate multimedia product accordingly,

preferably, in the aforesaid order recited.

In a fourth preferred embodiment of our method, the denomination is credited or debited to the respective user's account for any one or in combination of step (d), including upon the successful deposition of the user's multimedia product with the apparatus; step (e), including upon the multimedia product being verified as executable or in good working order, and recording in the data system accordingly; and step (h) upon the multimedia product being collected by the matched user.

In a fifth preferred embodiment of our method the data system hosts a database capable of storing records of each user's registration data, details of a multimedia product which he is ready to give away in the exchange and details of a multimedia product that he wishes to obtain in the exchange. Preferably, the data system includes a procedure capable of matching aforesaid exchange criteria and identifies the user to give away a multimedia product and the user wishing to obtain said multimedia product. Preferably still, more than one apparatuses are used to collect and dispense the multimedia products and wherein swapping of multimedia products between apparatuses is carried out.

In another aspect of our invention, our method's data system may preferably be hosted electronically in a wide area network (WAN), including the Internet, and includes database system coupled with communication modules enabling messages to be sent to and received from respective users to enable registration, input of exchange criteria, prompting to user to deposit and/or collect the multimedia products accordingly. Preferably, the data system includes a search engine for locating multimedia products desired by a user.

In a preferred embodiment of the data system, an interface to an apparatus is provided for collecting, storing and dispensing multimedia products in a jukebox storage manner wherein the collection, storage and dispensing are centrally and integrally controlled and managed. Preferably, the data system includes means of checking and accessing the contents of a multimedia product deposited with the apparatus, including checking for media surface defects, execute an executable program or application and attendant functions to verify that the multimedia product is in good working order.

In another aspect of our invention, an apparatus is disclosed for collecting, storing and dispensing multimedia products in a jukebox manner, wherein is provided means for marking a multimedia product deposited thereinto with a unique identifier which includes any one of barcode label, numeral code label, RFID tag and the like, means for transmitting and recording said unique identifier identify the multimedia product into a database comprised in a data system, and means for interfacing with said data system for controlling the jukebox operation of said apparatus. Preferably, the apparatus includes an interface, including a user input interface, to a data system of the aforesaid methods.

The apparatus may preferably be housed in a user-friendly kiosk which may include a jukebox for facilitating consumer-to-consumer exchange of articles of a dimension storable by said apparatus, wherein the articles include multimedia products, including DVD, VCD, CD-ROM, CD-R, CD-R/W, cartridges for games console and the like.

As a broad overview, our invention may be seen as embodying a system for facilitating exchange of multimedia products between a plurality of users wherein each user has at least one of (i) a multimedia product to be given up in exchange for either (ii) a multimedia product desired or (iii) denomination which may be used to acquire said multimedia product desired, including an apparatus as afore-described which is operatively interfaced with a data system implementing a method as afore-described, including its implementation over a WAN.

### LIST OF ACCOMPANYING DRAWINGS

The present invention will now be described in detail with reference to the accompanying drawing that follows, which is a representation of a specific embodiment or configuration, described as a non-limiting example or illustration of the workings of our method & apparatus, in which:

FIG. 1 shows a simplified schematic chronological flow diagram of one embodiment of our invention wherein a multimedia product is given up by a first user to a second user;

FIG. 2 illustrates a simplified schematic chronological flow diagram of another embodiment of our invention showing a mutual exchange of multimedia products between two matched users;

FIG. 3 shows a schematic block diagram of the first embodiment wherein a multimedia product is transferred from a first user to a second user;

FIG. 4 shows a schematic block diagram of the second embodiment wherein multimedia products are mutually exchanged between two matched users; and

FIG. 5 shows a flow chart diagram of a general configuration of the method of our invention linking a server to kiosks accessible by users over a wide area network.

### DETAILED DESCRIPTION OF SPECIFIC EMBODIMENTS

Central to our invention is a scheme or system comprising a data system and an apparatus collectively referred to as Game Exchange™. The data system may preferably be hosted on-line and accessible via a website and/or hosted in a standalone computer which is made accessible to users via a user interface at a kiosk providing access to the data system as well as for housing an apparatus used in our invention for collecting, storing and dispensing products to users.

In the broad, general embodiment of our invention, a method is provided for facilitating exchange of multimedia products between a plurality of users. Each user typically has a multimedia product, such as an electronic game or multimedia entertainment software contained in opto-magnetic form such as diskette, DVD, VCD, CD-ROM, CD-R, CD-R/W, or in integrated circuit (IC) based form such as flash memory cards in various formats (e.g. as SD, including mini- and micro-SD, XD, Memory Stick (MS), including MS-Duo, MS-Pro, MMC, CompactFlash (CF), etc.) which we referred to in this specification as “multimedia product”.

The user typically has used and grown tired of his multimedia product and is willing to give it up in exchange for a “new” multimedia product, i.e. one that he has not used or played before. The user accordingly has in his mind a particular or range of other multimedia products that he desires or willing to exchange the one at hand for. Alternatively, the user may not have any particular preference and is open to accepting any multimedia product in exchange. Yet another alternative is the user is willing to accept, for the time being, credit of certain value points commensurate with the multimedia product that he is willing to give up, whereby the value points may be used to obtain a particular multimedia product that he will like to have in the future. In any event, we shall collectively refer to the user's parameters on the multimedia product title that he is willing to give up, that he wants to obtain in exchange, etc. as “exchange criteria” in this specification.

In general, our method including collating each user's exchange criteria into a data system and matching a user with a multimedia product desired that is available in said data system, collecting said multimedia product desired from a willing user and dispensing said multimedia product desired to a desiring user.

The value points are credited and debited according to transactions. This include awarding amount of value points according to any one or combination of the following factors: original manufacturer's selling price, current market demand, age, and/or popularity of a title or content of the multimedia product, crediting an amount of value points to a user's account according to factors above upon collecting said multimedia product from said user, including converting from cash deposited by said user, and debiting an amount of value points from a user's account according to (a) upon dispensing said multimedia product, on a periodical basis to reflect delay in collecting, obsolescence or passe, and converting into cash by said user.

Of course, these are the basic parameters which may be used to determine the value points of a transaction and it is possible to include further parameters or exclude any of the present parameters according to business sense of the operator running the method and scheme. For instance, the “age” factor mentioned above may cover any one or both of (i) the age of a particular game since its release in the market by the publisher (as an indication of waning popularity through time), and (ii) how long the particular multimedia product has been registered and/or deposited with the Game Exchange™ scheme (as a slow match or take-up may indicate a lack of interest or small segment of interest by gamers in the particular game).

Apart from the value points, cash, coupons, vouchers and other tokens may also be prescribed as denominations exchangeable for equivalent value (hereinafter collectively referred to as “exchangeable denomination of value” or simply “denomination”) designated for a particular game or multimedia product.

exchangeable denomination of value, including cash and/or value points, which may be used in exchange to acquire said multimedia product desired;

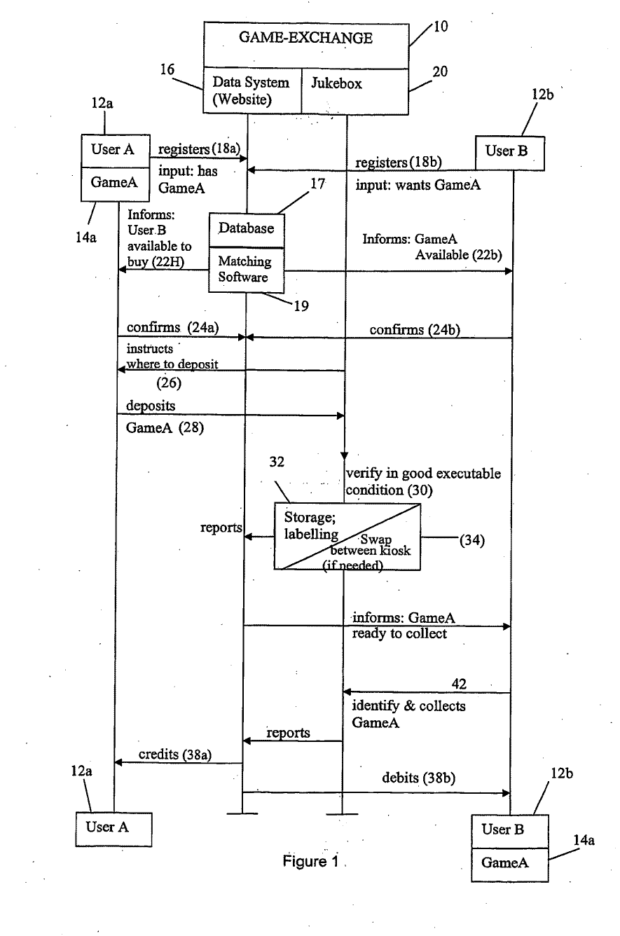

As an example of how the method of our invention works, we shall use a simplified example of a User A transacting directly with User B via our Game Exchange™ as illustrated in FIG. 1. It should be noted that this example is only a hypothetical and simplified situation and that in actual exchanging situations, there would be many more users interacting with our Game Exchange™ system whereby User A may obtain a multimedia product from User N who desires a product to be given up by User G, for instance.

With reference to FIG. 1, assume, a User A (12a) has a multimedia product which is a game entitled Game A (14a) which he is willing to give up in exchange for a specific amount of denomination, including value points, which is exchangeable for another multimedia product, or for a certain amount of value points determined by Game Exchange™ (10). Our Game Exchange™ scheme includes 2 major components, namely a data system (16) and an apparatus (20) which is controllable to work in a jukebox manner. In this first embodiment, User B (12b) may or may not have a product to be input into the scheme for exchange, let alone matching a product wanted by User A (12a).

User A (12a) and User B's (12b) respective exchange criteria may then be input into the data system (16) of Game Exchange™ when each of them independently registers (18a, 18b) as members and provide their respective exchange criteria to the system. The registration procedure may entail requiring the user to provide certain personal particulars such as their contact particulars (including mobile phone or land line which may receive SMS or voicemail), NRIC for identification purposes as well as choosing passwords of their own choice (or set by the system) for future access for security purposes.

By the term “data system”, we adopt the broad definition of “means, either manual or automatic, of converting data into action or decision information, including the forms, procedures, and processes which together provide an organized and interrelated means of recording, communicating, processing, and presenting information relative to a definable function or activity” provided by McGraw-Hill Dictionary of Electrical & Computer Engineering, 2004, and may include database (17), database management system, data processing system, search engine or procedure [hereinafter referred to as “matcher software” (19)], as well as electro-mechanical systems such as a jukebox for collecting, storing, retrieving and dispensing multimedia products. It may further include components such as automated communication components or modules enabling electronic communication means to be sent out from the Game Exchange™ system.

The data system (16) may preferably be hosted electronically in server in a wide area network (WAN), including the Internet, so as to enable components such as data processing system and its search engine to search and filter through the data collected in a database to find a match for User A (12a) and/or User B (12b) whereupon the users' respective exchange criteria are matched, in this case Game A willing to be given up by User A and wanted by User B. The data system may also preferably be coupled with communication modules to enable messages to be sent to and received from the respective users to enable registration, input of exchange criteria, prompting user to deposit and/or collect the multimedia product and for acknowledgement with the users accordingly of the completion of certain steps. For example, using the automated communication capability such as GSM module or electronic mail module, the data system may proceed to notify (22a, 22b) each of User A (12a) and User B (12b) by SMS, automated voice mail, e-mail or even by print and normal post or postcard of the successful match.

As shown in FIG. 1, upon both User A and User B's respective confirmation (24a, 24b) that they are desirous of proceeding with the transaction, Game Exchange™ will provide instructions to User A as to where to deposit Game A (14a), i.e. the location of the specific kiosk housing the jukebox (20), which location may be convenient to either User A or User B, or on a balance of convenience, depending on the parameters and value point reward system worked out under the scheme.

Alternatively, the parties may be requested to confirm (24a, 24b) that they each wish to proceed with the exchange by sending an acknowledgement to the system (10) especially if some time has elapsed since they register with Game Exchange™ (10). Upon User A's depositing Game A (14a) with a kiosk (20), the jukebox mechanism in the kiosk may verify that the product deposited is the correct game title and in good executable condition (30), such as free from physical defects, accessing its contents and running the programs contained therein to determine that it is in executable condition. A verified product may then be labeled with a unique identifier including a barcode or RFID tag, or merely stored in a jukebox manner without tagging but with the machine indexing its location in its record and memory to facilitate accurate retrieval later as required. The system (10) would then inform User B (12b) of the availability of his desired Game A (14a) at the particular kiosk so that he may proceed to collect his desired game from the kiosk.

It is preferable that the deposited product be labeled with an identifying code recognizable by the machine such as a barcode, reference numeral in machine readable form, numeral code label, RFID tag and the like and/or shelved by an indexing system of the jukebox so that it may be retrieved accurately. Similarly, it is preferable that some form of identification (ID) be provided to the system before allowing a user to collect their desired product from the jukebox (20). Such ID may be the same password used in registering and accessing their account online or a specific ID provided by the system for that particular transaction or collection.

Upon successful collection of Game A (14a) by User B (12b), User A's account may be credited (36) with a predetermined amount of denomination which may be used for future transactions. User B's account may then be debited (38) with a predetermined amount of denomination accordingly. The difference between the debit and credit would be taken as exchange fee earned by Game Exchange™ under the scheme.

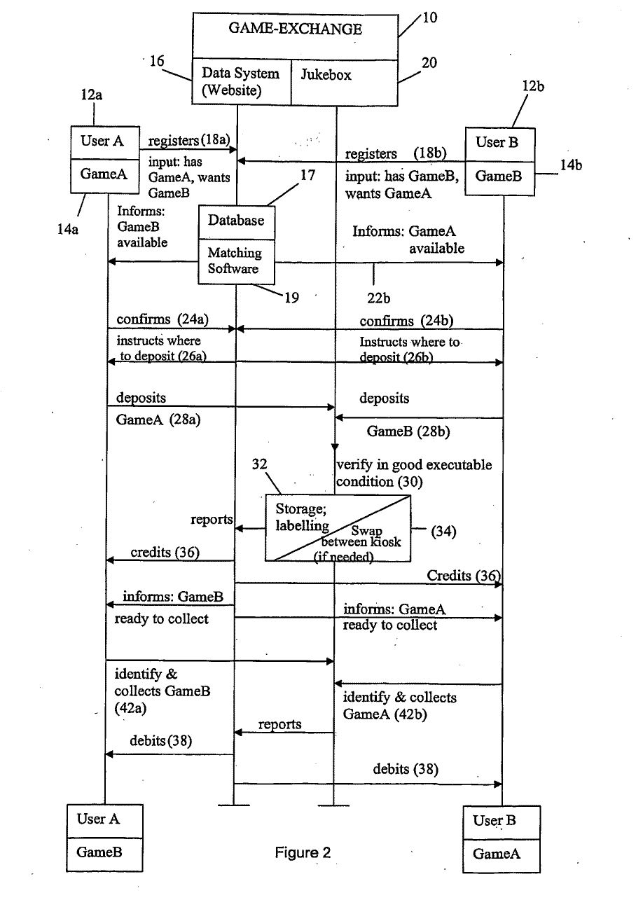

In a second embodiment, as shown in FIG. 2, a direct match is made between User A and User B, wherein User A (12a) has Game A (14a) which he is willing to part with in exchange for Game B (14b) while User B (12b) has Game B (14b) which he is willing to part with in exchange for Game A (14a). As in the first embodiment, both parties may proceed to register themselves, or if they are already registered as users, may proceed to create new exchange requests wherein their exchange criteria may be input into database (17) and matched by the matching software (19). Upon a successful match, the scheme informs both User A (22a) and User B (22b) of the match. It may optionally request for their respective confirmations to proceed and instructs them where to deposit (26a, 26b) their respective products.

Both parties may proceed to deposit their respect Game A (14a) and Game B (14b) at a common, nearest or most convenient kiosk (20) which may be described as a jukebox capable of collecting, storing and dispensing multimedia products with an automatic robotic arm. Optionally, the system (10) may instruct (26a, 26b) each of User A and User B to deposit their respective products into kiosks at specific locations depending on their registered addresses or at a common kiosk based on a balance of convenience between the exchanging parties.

Upon the parties' depositing the respective products (28a, 28b) with the designated kiosk (20), the appropriate components in the jukebox may proceed to process each of the products automatically as previously described. The system (10) would then inform each of User A (12a) and User B (12b) of the availability of their respective desired Game B (14b) and Game A (14a) so that they may proceed to collect their desired games accordingly.

It is preferable that some form of identification (ID) be provided to the system before allowing a user to collect their desired product from the jukebox (20). Such ID may be the same password used in registering and accessing their account online or a specific ID provided by the system for that particular transaction or collection.

Value points may be credited (36) or debited (38) to the respective user's account accordingly at certain stages of the transaction. For example, upon the successful deposition of the user's multimedia product with the apparatus, value points may be awarded. Upon the product deposited into the jukebox being verified as in good working order, more points may be awarded or the previous value points be confirmed or allowed for trading. Upon the product being collected by the matched user desiring the product, more value points may be awarded or confirmed or allowed for trading.

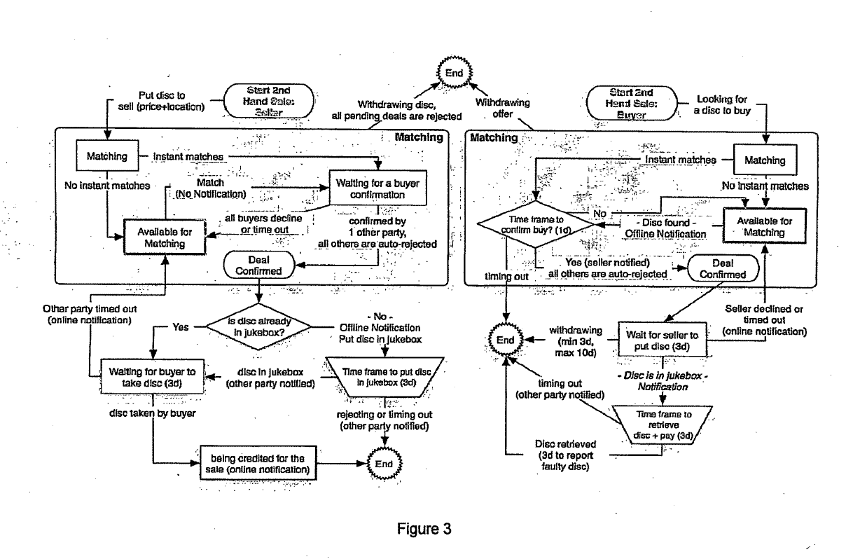

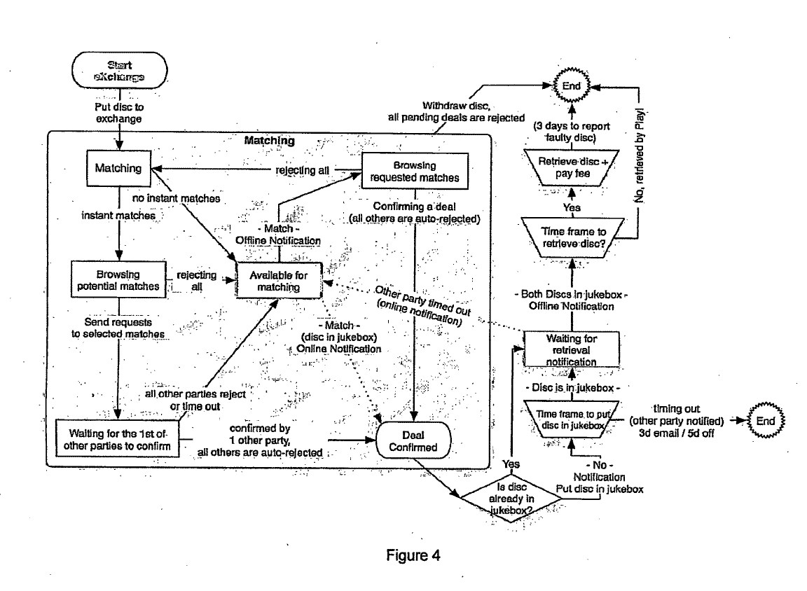

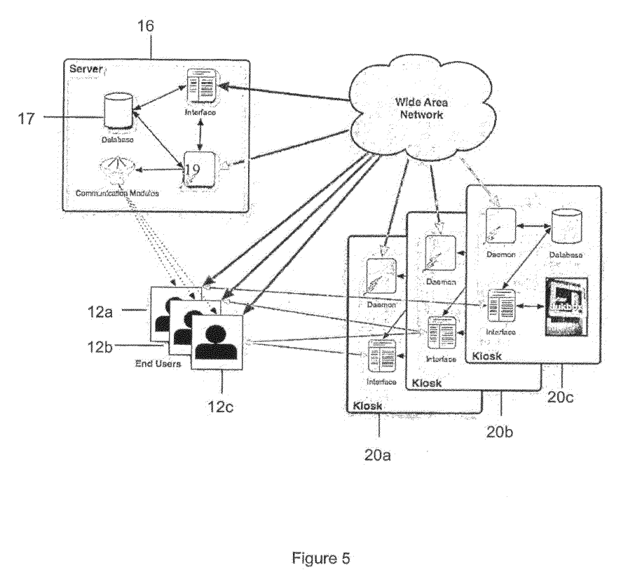

Schematic block diagrams representing the respective first and second embodiments' logic flow are provided in FIG. 3 and FIG. 4 respectively. It should be noted that these logic diagrams cover most eventualities including transactions being aborted midway such as when a “selling” party declined and failed to respond within a given time-frame (“timed out”). In FIG. 5, a highly simplified interaction between the Game Exchange™ with a plurality of users (12a, 12b, 12c) and a plurality of kiosk housing the jukeboxes (20a, 20b and 20c) are shown to provide an overall view of the scheme. The Game Exchange™ is shown represented by the data system (16) comprising the major components of database (17), matching software (19), and an interface with a wide area network such as the Internet, and communication modules.

As previously described, the data system may host a database capable of storing records of each user's registration data, details of a multimedia product which he is ready to give away in the exchange and details of a multimedia product that he wishes to obtain in the exchange. Preferably, it includes matching software which is essentially a search engine or procedure capable of matching aforesaid exchange criteria and identifying the user to give away a multimedia product and the user wishing to obtain said multimedia product. The data system may include an interface to an apparatus for collecting, storing and dispensing multimedia products in a jukebox storage manner wherein the collection, storage and dispensing are centrally and integrally controlled and managed.

As mentioned above, the transaction may involve requiring the matched users to deposit at different kiosks housing separate jukeboxes. In such circumstances, there will be a swapping operation (34) between jukeboxes or kiosks by the operator as directed by the system. In this way, the desired product may be retrieved by the operator from the jukebox where User B has deposited his Game B so that it may be deposited into the jukebox at the location which will be visited by User A. Upon successfully identifying himself, each of User A and User B may collect (42a, 42b) their respective Game B and Game A.

Other possible variations to the general concept of our invention may include allowing retail sales of new (i.e. unused products) to be dispensed to a user after deducting for the value points of the user's used product deposited in the jukebox and allowing the user to top up to the value of the new product by cash. Alternatively, the user may choose to accumulate value points by depositing more than one product in exchange for one high value product.

From the above description on the general concept, features and working principles of the invention and its specific embodiments, it would be obvious to a person skilled in the art that there are many variations and alternative embodiments that may be used in substitution of the aforesaid parts, materials, steps or processes. Many of the various parts, components, materials and alternative configurations or embodiments that are not specifically described herein may be used to effectively work the concept and working principles of this invention. They are not to be considered as departures from the present invention but shall be considered as falling within the letter and scope of the following claims.

1. A method for facilitating exchange of multimedia products between a plurality of users wherein at least a user has at least
(i) a multimedia product to be given up in exchange for either
(ii) a multimedia product desired or
(iii) exchangeable denomination of value, including cash and/or value points, which may be used in exchange to acquire said multimedia product desired;
(hereinafter collectively referred to as “exchange criteria”), said method including the steps of:
(a) collating each user's exchange criteria into a data system;
(b) matching at least a user willing to part with a multimedia product with at least a user desiring said multimedia product in said data system;
(c) collecting said multimedia product desired from said willing user;
(d) dispensing said multimedia product desired to said desiring user.

2. A method according to claim 1 wherein the denomination is credited and debited according to transactions, including
(a) awarding denomination according to at least one or combination of the following factors: original manufacturer's selling price, current market demand, age, and/or popularity of a title or content of the multimedia product;
(b) crediting an amount of value points to a user's account according to paragraph (a) above upon collecting said multimedia product from said user, including converting from cash deposited by said user;
(c) debiting an amount of value points from a user's account according to (a) upon dispensing said multimedia product, on a periodical basis to reflect delay in collecting, obsolescence or passé, and converting into cash by said user.

3. A method according to claim 1 wherein the steps (a) to (d) are in the order recited.

4. A method for facilitating exchange of multimedia products between a plurality of users wherein at least a first user and a second user each respectively has at least
(i) a first and second multimedia products to be given up respectively in exchange for either
(ii) a second and first multimedia products desired respectively, and/or
(iii) exchangeable denomination of value, including cash and/or value points, which may be used in exchange to acquire said multimedia product desired;
said method including the steps of:
(a) collating each of said first and second users' exchange criteria into a data system;
(b) matching at least said first user willing to part with said first multimedia products with at least said second user desiring said first multimedia product, and vice versa in said data system;
(c) collecting said multimedia product desired from each of said first and second users;
(d) dispensing said multimedia product desired to each of said first and second user.

5. A method for facilitating exchange of multimedia products between a plurality of users including at least a first user and a second user wherein
said first user has a first multimedia product which he is willing to exchange for denomination and/or another multimedia product, including a second multimedia product or part or multiple units thereof;
said second user has said second multimedia product which he is willing to exchange for credit points or another multimedia, including said first multimedia product;
said information on each user's multimedia product to be given away and multimedia product desired referred hereinafter collectively as “exchange criteria”;
said method including the steps of:
(a) each of said first and second user independently registering and inputting aforesaid exchange criteria into a data system;
(b) data system matching aforesaid exchange criteria and identify said first and second users;
(c) data system informing each of said first and second users to deposit said first and second multimedia products respectively with at least an apparatus for collecting, storing and dispensing multimedia products in a jukebox manner;
(d) said first and second users depositing said first and second multimedia products with said apparatus accordingly;
(e) said apparatus verifying and updating said first and second multimedia products' deposition with said data system accordingly;
(f) said data system informing said first and second users to collect said second and first multimedia products accordingly from said apparatus and providing respective identification to said first and second users;
(g) each of said first and second user independently presenting respective identification at said apparatus; and
(h) said apparatus authenticating each of said users' identification and dispensing the appropriate multimedia product accordingly.

6. A method according to claim 5 wherein the steps (a) to (h) are in the order recited.

7. A method according to any one of claims 2, 4 and 5 wherein denomination is credited or debited to the respective user's account for any one or in combination of:
step (d), including upon the successful deposition of the user's multimedia product with the apparatus;
step (e), including upon the multimedia product being verified as executable or in good working order, and recording in the data system accordingly; and
step (h) upon the multimedia product being collected by the matched user.

8. A method according to claim 5 wherein the data system hosts a database capable of storing records of each user's registration data, details of a multimedia product which he is ready to give away in the exchange and details of a multimedia product that he wishes to obtain in the exchange.

9. A method according to claim 8 wherein the data system includes a procedure capable of matching aforesaid exchange criteria and identify the user to give away a multimedia product and the user wishing to obtain said multimedia product.

10. A method according to claim 5 wherein more than one apparatuses are used to collect and dispense the multimedia products, and wherein swapping of multimedia products between apparatuses is carried out.

11. A method according to any one of claims 1-10 wherein the data system is hosted electronically in a wide area network (WAN), including the Internet, and includes database system coupled with communication modules enabling messages to be sent to and received from respective users to enable registration, input of exchange criteria, prompting to user to deposit and/or collect the multimedia products accordingly.

12. A method according to claim 11 wherein the data system includes a search engine for locating multimedia products desired by a user.

13. A method according to claim 12 wherein the data system includes an interface to an apparatus for collecting, storing and dispensing multimedia products in a jukebox storage manner wherein the collection, storage and dispensing are centrally and integrally controlled and managed.

14. A method according to claim 13 wherein the data system includes means of checking and accessing the contents of a multimedia product deposited with the apparatus, including checking for media surface defects, execute an executable program or application and attendant functions to verify that the multimedia product is in good working order.

15. An apparatus for collecting, storing and dispensing multimedia products in a jukebox manner, comprising at least one of:
means for marking a multimedia product deposited thereinto with a unique identifier which includes any one of barcode label, numeral code label, RFID tag and the like;
means for transmitting and recording said unique identifier identify the multimedia product into a database comprised in a data system;
means for interfacing with said data system for controlling the jukebox operation of said apparatus.
wherein said means are disposed to facilitate exchange of products between a plurality of users based on exchange criteria.

16. An apparatus according to claim 15 including an interface to a data system of a method according to any one of the preceding claims.

17. An apparatus according to claim 15 including user input interface to a data system of a method according to any one of the preceding claims.

18. An apparatus according to any one of claims 15 to 17 housed in a kiosk wherein user interfacing, input and display means are provided to enable a user to perform at least one of registration, authentication, depositing a multimedia product, browsing other multimedia products available for exchange, and retrieving multimedia product.

19. An apparatus, including a jukebox, for facilitating consumer-to-consumer exchange of articles of a dimension storable by said apparatus, wherein the articles include multimedia products, including DVD, VCD, CD-ROM, CD-R, CD-R/W, cartridges for games console and the like.

20. A system for facilitating exchange of multimedia products between a plurality of users wherein each user has at least one of
(i) a multimedia product to be given up in exchange for either
(ii) a multimedia product desired or
(iii) denomination which may be used to acquire said multimedia product desired, said system including
an apparatus according to any one of claims 12 to 14 operatively interfaced with
a data system implementing a method according to any one of claims 1 to 11, including implementation over a WAN.
